(19) United States
(12) Patent Application Publication
(10) Pub. No.: US 2021/0364676 A1
(43) Pub. Date: Nov. 25, 2021

(54) DIFFUSER FILM AND METHOD FOR MANUFACTURING SAME

(71) Applicant: WUHAN CHINA STAR OPTOELECTRONICS TECHNOLOGY CO., LTD., Wuhan (CN)

(72) Inventor: Guiyang Zhang, Wuhan (CN)

(73) Assignee: WUHAN CHINA STAR OPTOELECTRONICS TECHNOLOGY CO., LTD., Wuhan (CN)

(21) Appl. No.: 16/316,917

(22) PCT Filed: Nov. 1, 2018
(86) PCT No.: PCT/CN2018/113259

§ 371 Date: Jan. 10, 2019

(30) Foreign Application Priority Data
Sep. 28, 2018 (CN) 201811139694.1

(51) Int. Cl. G02B 5/02; G02B 1/04; B29D 11/00; B29B 7/90

(52) U.S. Cl. CPC G02B 5/0278; G02B 5/0242; B29K 2033/12; B29D 11/00798; B29B 7/90; G02B 1/04

(57) ABSTRACT

Diffuser Elms may include a substrate and a plurality of diffusing particles uniformly distributed in the substrate. An absolute value of a difference between a refractive index of the diffusing particles and a refractive index of the substrate is less than or equal to 0.25, a diameter of the diffusing panicles ranges from 1 μm to 6 μm, and a weight percentage of the diffusing particles in the substrate ranges from 1‰ to 12‰, such that both a light transmittance and a haze of the diffuser film are greater than 80%.

### FIELD OF INVENTION

The present disclosure relates to the field of display technology, and more particularly to a diffuser film and a method for manufacturing same.

### BACKGROUND

Diffuser films are an essential component included in various types of display devices, and is used to raise display effect of display devices by expanding a point light source or a linear light source into a planar light source. Expansion of a point light source or a linear light source into a planar light source is achieved by a plurality of diffusing particles uniformly distributed in diffuser film, where the diffusing particles scatter incident light towards other directions. Scattering ability of diffuser film is determined by measuring “haze” of diffuser film. However, to manufacture a diffuser film, while haze of diffuser film is increased, generally lowers brightness of display devices. It is difficult to manufacture a diffuser film having both a high haze and a high light transmittance at the same time.

Therefore, there is a need to provide a diffuser film and a method for manufacturing same, in order to solve above-said problems existing in prior art.

### SUMMARY OF DISCLOSURE

The present disclosure provides a diffuser film and a method for manufacturing same in order to solve the problems existing in the prior art, where haze and light transmittance of diffuser film cannot be increased at the same time.

To solve the aforementioned problems, the present disclosure provides a diffuser film, comprising:
a substrate; and
a plurality of diffusing particles uniformly distributed in the substrate;
wherein an absolute value of a difference between a refractive index of the diffusing particles and a refractive index of the substrate is less than or equal to 0.25, a diameter of the diffusing particles ranges from 1 μm to 6 μm, and a weight percentage of the diffusing particles in the substrate ranges from 1‰ to 12‰, such that both a light transmittance and a haze of the diffuser film are greater than 80%.

In accordance with one preferred embodiment of the present disclosure, the substrate is made of an organic resin, and the organic resin is polymethyl methacrylate (PMMA) or polyethylene terephthalate (PET); and the diffusing particles are made of an organic material or an inorganic material, and the organic material is an epoxy resin or polydimethylsiloxane (PDMS), the inorganic material is selected from titanium dioxide, silicon dioxide, or zinc oxide.

In accordance with one preferred embodiment of the present disclosure, the absolute value of the difference between the refractive index of the diffusing particles and the refractive index of the substrate is about 0.07, the diameter of the diffusing particles is about 4 μm, and the weight percentage of the diffusing particles in the substrate is about 5‰.

Additionally, the present disclosure provides a backlight module, comprising the diffuser film as described above.

Moreover, the present disclosure provides a display panel having a backlight module, wherein the backlight module comprises the diffuser film as described above.

Furthermore, the present disclosure provides a display device having a display panel, wherein the display panel includes a backlight module, and the backlight module comprises the diffuser film as described above.

In addition, the present disclosure provides a method for manufacturing a diffuser film, comprising steps of:
mixing and injection-molding a plurality of diffusing particles and an organic resin using an injection molding technique to form the diffuser film;
wherein an absolute value of a difference between a refractive index of the diffusing particles and a refractive index of the organic resin is less than or equal to 0.25, a diameter of the diffusing particles ranges from 1 μm to 6 μm, and a weight percentage of the diffusing particles in the organic resin ranges from 1‰ to 12‰, such that both a light transmittance and a haze of the diffuser film are greater than 80%.

In accordance with one preferred embodiment of the present disclosure, the method further comprises steps of:
uniformly mixing the diffusing particles and the organic resin to forms a mixture;
heating the mixture at 85° C. for 4 hours;
injection-molding the mixture with a screw type injection molding machine or a piston type injection molding machine to form an injection-molded product, wherein a screw temperature of the injection molding machine is controlled to range between 160° C. and 250° C., a head temperature of the injection molding machine is controlled to range between 220° C. and 260° C., a screw rotation speed of the injection molding machine is controlled to range between 120 rev/min and 130 rev/min, and the injection pressure of the injection molding machine is controlled to range between 10 MPa and 80 MPa; and
place the injection-molded product in a hot air circulation oven at a temperature between 70° C. and 80° C. for 4 hours, so as to eliminate stress existing inside of the injection-molded product.

In accordance with one preferred embodiment of the present disclosure, the organic resin is polymethyl methacrylate (PMMA) or polyethylene terephthalate (PET); and the diffusing particles are made of an organic material or an inorganic material, and the organic material is an epoxy resin or polydimethylsiloxane (PDMS), the inorganic material is selected from titanium dioxide, silicon dioxide, or zinc oxide.

In accordance with one preferred embodiment of the present disclosure, the absolute value of the difference between the ref active index of the diffusing particles and the refractive index of the organic resin is about 0.07, the diameter of the diffusing particles is about 4 μm, and the weight percentage of the diffusing particles in the organic resin is about 5‰.

Compared to the prior art, the present disclosure provides a diffuser film and a method for manufacturing same. The present disclosure is characterized by using an organic transparent resin as a raw material to make up a substrate, and by mixing a plurality of diffusing particles having micrometer-scale diameter into the organic resin, where an absolute value of a difference between a refractive index of the diffusing particles and a refractive index of the substrate, a diameter of the diffusing particles, and a weight percentage of the diffusing particles mixed in the substrate are controlled, so as to manufacture a diffuser film having both a high light transmittance and a high haze.

### BRIEF DESCRIPTION OF DRAWINGS

FIG. 1 is a schematic diagram showing a structure of a diffuser film according to one preferred embodiment of the present disclosure.

FIG. 2 is a graph showing haze and light transmittance of a diffuser film as lights having different wavelengths pass through the diffuser film according to one preferred embodiment of the present disclosure.

### DETAILED DESCRIPTION

The following embodiments refer to the accompanying drawings for exemplifying specific implementable embodiments of the present disclosure. Moreover, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, the same reference symbol represents the same or similar components.

The present disclosure is characterized by using an organic transparent resin as a raw material to make up a substrate, and by mixing a plurality of diffusing particles having micrometer-scale diameter into the organic resin, where an absolute value of a difference between a refractive index of the diffusing particles and a refractive index of the substrate, a diameter of the diffusing particles, and a weight percentage of the diffusing particles mixed in the substrate are controlled, so as to manufacture a diffuser film having both a high light transmittance and a high haze. With regard to refractive index of diffusing particles, size (i.e., diameter) of diffusing particles, and concentration of diffusing particles in substrate, detailed explanation is provided below:
1. With regard to refractive index of diffusing particles: If the refractive index of the diffusing particles and the refractive index of the substrate surrounding the diffusing particles are nearly the same, the diffuser film as a whole has a much more uniform refractive index, and the probability that lights are scattered forward is much higher. In the extreme condition where the refractive index of the diffusing particles is just equal to the refractive index of the substrate, the diffuser film can be considered fully transparent if reflection loss at outside boundaries is omitted. In this case, the light transmittance of the diffuser film is the light transmittance of maximum value in ideal condition.
2. With regard to diameter of diffusing particles: If the diameter of the diffusing particles is getting smaller, the scattering ability of the diffusing particles fur lights having short wavelengths would be getting stronger, and the scattering effect of the diffusing particles for lights having short wavelengths is increased. As the diameter of the diffusing particles is gradually increased, the scattering effect of the diffusing particles for lights having long wavelengths is increased. Once the diameter of the diffusing particles is increased to reach a certain value, the scattering abilities of the diffusing particles for short and long light wavelengths (e.g., blue light and red light) are basically the same. In this condition, the diffusing effect of the diffuser film will not vary even if light wavelength is varied. In addition, in this condition, the diameter of the diffusing particles is that selected by the embodiments of the present disclosure to manufacture the diffuser film. This diameter of the diffusing particles will not cause dispersion of light. And, such particle diameter is used to manufacture a diffuser film that could be widely used in the display devices.
3. With regard to concentration of diffusing particles in substrate: The concentration of the diffusing particles in the substrate influences mean free path of photons. With gradual increase of concentration of the diffusing particles in the substrate, photons will be scattered much more times after photons enter the diffuser film. This will further shorten mean free path of photons, further increase the probability that lights are scattered backward, and thus further increase the haze of the diffuser film. However, to obtain a high transmittance of the diffuser film, the concentration of the diffusing particles in the substrate cannot be too high. On the other hand, if the concentration of the diffusing particles in the substrate is too low, the haze of the diffuser film will be too low. Thus, the concentration of the diffusing particles in the substrate is also one of the key parameter that has to be determined to manufacture a diffuser film having both a high light transmittance and a high haze.

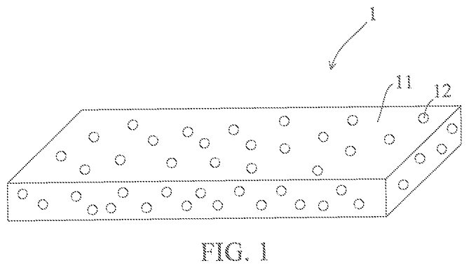

Please refer to FIG. 1, which is a schematic diagram showing a structure of a diffuser film according to one preferred embodiment of the present disclosure.

As shown in FIG, 1, the embodiment of the present disclosure provides a diffuser film 1. The diffuser film 1 includes a substrate 11 and a plurality of diffusing particles 12 uniformly distributed in the substrate 11. According to this embodiment, an absolute value of a difference between a refractive index of the diffusing particles 12 and a refractive index of the substrate 11 is less than or equal to (i.e., not larger than) 0.25, a diameter of the diffusing particles 12 ranges from 1 μm to 6 μm, and a weight percentage of the diffusing particles 12 in the substrate 11 ranges from 1‰ to 12‰, such that both a light transmittance and a haze of the diffuser film 1 are greater than 80%;

The substrate 11 is made of an organic resin. For example, the organic resin is polymethyl methacrylate (PMMA) having a refractive index of about 1.49 or polyethylene terephthalate (PET) having a refractive index of about 1.65.

Moreover, the diffusing particles 12 are made of an organic material or an inorganic material. For example, the organic material is an epoxy resin having a refractive index of about 1.58 or polydimethylsiloxane (PDMS) having a refractive index of about 1.41, and the inorganic material is selected from titanium dioxide (TiO₂) having a refractive index of about 2.35, silicon dioxide (SIG)) having a refractive index of about 1.46, or zinc oxide (ZnO) having a refractive index of about 2.

According to one preferred embodiment of the present disclosure, the absolute value of the difference between the refractive index of the diffusing particles 12 and the refractive index of the substrate 11 is controlled to be less than or equal to 0.25. In addition, regarding organic materials (such as PMMA, PS, epoxy PDMS, and etc.), different polymerization parameters could be selected to form the organic materials having slightly different values of refractive index. Even a same type of materials can be used for both substrate and diffusing particles to manufacture the diffuser film. For example, PMMA having a refractive index is used as a substrate, and PMMA having another refractive index is used as diffusing particles, and they are mixed to manufacture the diffuser film. This could reduce stress between the diffusing particles and the substrate, and thus the produced diffuser film has outstanding properties,

The inventor of the subject invention discovers that, when the absolute value of the difference between the refractive index of the diffusing particles 12 and the refractive index of the substrate 11 is 0.1, the diameter of the diffusing particles 12 is 1 μm, and the weight percentage of the diffusing particles 12 in the substrate 11 ranges from 1‰ to 12‰, the haze of the diffuser film is between 10% and 65%, and the light transmittance of the diffuser film is between 95% and 45%. When the absolute value of the difference between the refractive index of the diffusing particles 12 and the refractive index of the substrate 11 is 0.1, the diameter of the diffusing particles 12 is 6 μm, and the weight percentage of the diffusing particles 12 in the substrate 11 ranges from 1‰ to 12‰, the haze of the diffuser film is between 30% and 95%, and the light transmittance of the diffuser film is between 85% and 30%.

The inventor of the subject invention also discovers that, when the absolute value of the difference between the refractive index of the diffusing particles 12 and the refractive index of the substrate 11 is 0.2, the diameter of the diffusing particles 12 is 1 μm, and the weight percentage of the diffusing particles 12 in the substrate 11 ranges from 1‰ to 12‰, the haze of the diffuser film is between 25% and 80%, and the light transmittance of the diffuser film is between 90% and 25%. When the absolute value of the difference between the refractive index of the diffusing particles 12 and the refractive index of the substrate 11 is 0.2, the diameter of the diffusing particles 12 is 6 μm, and the weight percentage of the diffusing particles 12 in the substrate 11 ranges from 1‰ to 12‰, the haze of the diffuser film is between 45% and 97%, and the light transmittance of the diffuser film is between 70% and 15%.

By controlling the absolute value of the difference between the refractive index of the diffusing particles 12 and the refractive index of the substrate 11, the diameter of the diffusing particles 2, and the weight percentage of the diffusing particles 12 in the substrate 11, the haze and light transmittance of the diffuser film could be controlled to be between 10% and 97%. Thus, the produced diffuser film can be applied in different display devices.

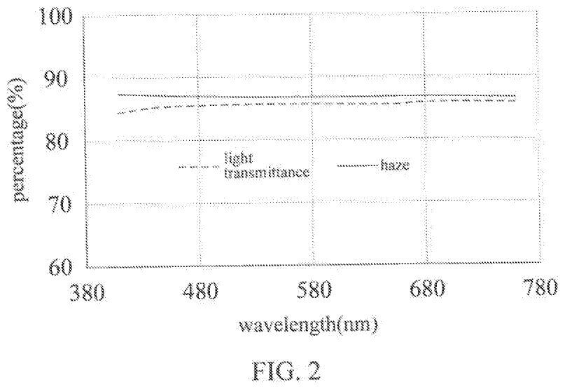

Please refer to FIG, 2, which is a graph showing haze and light transmittance of a diffuser film as lights having different wavelengths pass through the diffuser film according to one preferred embodiment of the present disclosure. As shown in FIG. 2, by controlling the absolute value of the difference between the refractive index of the diffusing particles 12 and the refractive index of the substrate 11 to be 0.07, the diameter of the diffusing particles 12 to be 4 μm, and the weight percentage of the diffusing particles 12 in the substrate 11 to be 5‰, both the haze and light transmittance of the diffuser film of the present disclosure are greater than 80% as lights having wavelengths of 400-750 nm (i.e., from wavelength of UV light to wavelength of red light) pass through the diffuser film. Therefore, the diffuser film manufactured according to the present disclosure solves the problems existing in the prior art, where the haze and the light transmittance of the diffuser film cannot be increased at the same time.

Additionally, the embodiment of the present disclosure provides a backlight module, comprising the diffuser film as described above.

Moreover, the embodiment of the present disclosure provides a display panel (such as an OLED display panel, a micro-LED display pane, an LED display panel, and etc.) having a backlight module, wherein the backlight module comprises the diffuser film as described above.

Furthermore, the embodiment of the present disclosure provides a display device (such as a mobile phone, a television, a display screen, or any other display apparatuses) having a display panel, wherein the display panel includes a backlight module, and the backlight module comprises the diffuser film as described above.

In addition, the embodiment of the present disclosure provides a method for manufacturing a diffuser film, comprising steps of:
mixing and injection-molding a plurality of diffusing particles and an organic resin using an injection molding technique to form the diffuser film;
wherein an absolute value of a difference between a refractive index of the diffusing particles and a refractive index of the organic resin is less than or equal to 0.25, a diameter of the diffusing particles ranges from 1 μm to 6 μm, and a weight percentage of the diffusing particles in the organic resin ranges from 1‰ to 12‰, such that both a light transmittance and a haze of the diffuser film are greater than 80%.

Specifically, the method for manufacturing the diffuser film includes steps of:
uniformly mixing the diffusing particles and the organic resin to form a mixture;
heating the mixture at 85° C. for 4 hours;
injection-molding the mixture with a screw type injection molding machine or a piston type injection molding machine to form an injection-molded product, wherein a screw temperature of the injection molding machine is controlled to range between 160° C. and 250° C., a head temperature of the injection molding machine is controlled to range between 220° C. and 260° C., a screw rotation speed of the injection molding machine is controlled to range between 120 rev/min and 130 rev/min, and the injection pressure of the injection molding machine is controlled to range between 10 MPa and 80 MPa; and
place the injection-molded product in a hot air circulation oven at a temperature between 70° C. and 0° C. for 4 hours, so as to eliminate stress existing inside of the injection-molded product.

The organic resin is polymethyl methacrylate (PMMA) having a refractive index of about 1.49 or polyethylene terephthalate (PET) having a refractive index of about 1.65.

Moreover, the diffusing particles 12 are made of an organic material or an inorganic material. For example, the organic material is an epoxy resin having a refractive index of about 1.58 or polydimethylsiloxane (PDMS) having a refractive index of about 1.41, and the inorganic material is selected from titanium dioxide (TiO₂) having a refractive index of about 2.35, silicon dioxide (SiO₂) having a refractive index of about 1.46, or zinc oxide (ZnO) having a refractive index of about 2.

Compared to the prior art, the present disclosure provides a diffuser film and a method for manufacturing same. The present disclosure is characterized by using an organic transparent resin as a raw material to make up a substrate, and by mixing a plurality of diffusing particles having micrometer-scale diameter into the organic resin, where an absolute value of a difference between a refractive index of the diffusing particles and a refractive index of the substrate, a diameter of the diffusing particles, and a weight percentage of the diffusing particles mixed in the substrate are controlled, so as to manufacture a diffuser film having both a high light transmittance and a high haze.

While the present disclosure has been described with the aforementioned preferred embodiments, it is preferable that the above embodiments should not be construed as limiting of the present disclosure. Anyone having ordinary skill in the art can make a variety of modifications and variations without departing from the spirit and scope of the present disclosure as defined by the following claims.

1. A diffuser film, comprising:
a substrate; and
a plurality of diffusing particles uniformly distributed in the substrate;
wherein an absolute value of a difference between a refractive index of the diffusing particles and a refractive index of the substrate is less than or equal to 0.25, a diameter of the diffusing particles ranges from 1 μm to 6 μm, and a weight percentage of the diffusing particles in the substrate ranges from 1‰ to 12‰, such that both a light transmittance and a haze of the diffuser film are greater than 80%;
wherein the substrate is made of an organic resin, and the organic resin is polymethyl methacrylate (PMMA) or polyethylene terephthalate (PET); and
wherein the diffusing particles are made of an organic material or an inorganic material, and the organic material is an epoxy resin or polydimethylsiloxane (PDMS), the inorganic material is selected from titanium dioxide, silicon dioxide, or zinc oxide.

2. The diffuser film according to claim 1, wherein the absolute value of the difference between the refractive index of the diffusing particles and the refractive index of the substrate is about 0.07, the diameter of the diffusing particles is about 4 μm, and the weight percentage of the diffusing particles in the substrate is about 5%.

3. A diffuser film, comprising:
a substrate; and
a plurality of diffusing particles uniformly distributed in the substrate;
wherein an absolute value of a difference between a refractive index of the diffusing particles and a refractive index of the substrate is less than or equal to 0.25, a diameter of the diffusing particles ranges from 1 μm to 6 μm, and a weight percentage of the diffusing particles in the substrate ranges from 1‰ to 12‰, such that both a light transmittance and a haze of the diffuser film are mater than 80%.

4. The diffuser film according to claim 3, wherein
the substrate is made of an organic resin, and the organic resin is polymethyl methacrylate (PMMA) or polyethylene terephthalate (PET); and
the diffusing particles are made of an organic material or an inorganic material, and the organic material is an epoxy resin or polydimethylsiloxane (PDMS), the inorganic material is selected from titanium dioxide, silicon dioxide, or zinc oxide.

5. The diffuser film according to claim 3, wherein the absolute value of the difference between the refractive index of the diffusing particles and the refractive index of the substrate is about 0.07, the diameter of the diffusing particles is about 4 μm, and the weight percentage of the diffusing particles in the substrate is about 5‰.

6. A backlight module, comprising the diffuser film according to claim 3.

7. A display panel having a backlight module, wherein the backlight module comprises the diffuser film according to claim 3.

8. A display device having a display panel, wherein the display panel includes a backlight module, and the backlight module comprises the diffuser film according to claim 3.

9. A method for manufacturing a diffuser film, comprising steps of:
mixing and injection-molding a plurality of diffusing particles and an organic resin using an injection molding technique to form the diffuser film;
wherein an absolute value of a difference between a refractive index of the diffusing particles and a refractive index of the organic resin is less than or equal to 0.25, a diameter of the diffusing particles ranges from 1 μm to 6 μm, and a weight percentage of the diffusing particles in the organic resin ranges from 1‰ to 12‰, such that both a light transmittance and a haze of the diffuser film are greater than 80%.

10. The method for manufacturing the diffuser film according to claim 9, wherein the method further comprises steps of:
uniformly mixing the diffusing particles and the organic resin to form a mixture;
heating the mixture at 85° C. for 4 hours;
injection-molding the mixture with a screw type injection molding machine or a piston type injection molding machine to form an injection-molded product, wherein a screw temperature of the injection molding machine is controlled to range between 160° C. and 250° C., a head temperature of the injection molding machine is controlled to range between 220° C. and 260° C., a screw rotation speed of the injection molding machine is controlled to range between 120 rev/min and 130 rev/min, and the injection pressure of the injection molding machine is controlled to range between 10 MPa and 80 MPa; and
place the injection-molded product in a hot air circulation oven at a temperature between 70° C. and 80° C. for 4 hours, so as to eliminate stress existing inside of the injection-molded product.

11. The method for manufacturing the diffuser film according to claim 9, wherein
the organic resin is polymethyl methacrylate (PMMA) or polyethylene terephthalate (PET); and
the diffusing particles are made of an organic material or an inorganic material, and the organic material is an epoxy resin or polydimethylsiloxane (PDMS), the inorganic material is selected from titanium dioxide, silicon dioxide, or zinc oxide.

12. The method for manufacturing the diffuser film according to claim 9, wherein the absolute value of the difference between the refractive index of the diffusing particles and the refractive index of the organic resin is about 0.07, the diameter of the diffusing particles is about 4 μm, and the weight percentage of the diffusing particles in the organic resin is about 5%.
